(19) United States
(12) Patent Application Publication
(10) Pub. No.: US 2010/0184492 A1
(43) Pub. Date: Jul. 22, 2010

(54) MOBILE PHONE HAVING POP-UP KEYPAD

(75) Inventors: Bo Ra KIM, Seoul (KR); Hyun Seop KIM, Seoul (KR); Chang Hwan HWANG, Seongnam-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/688,167

(22) Filed: Jan. 15, 2010

(30) Foreign Application Priority Data
Jan. 16, 2009 (KR) 10-2009-0003753

(51) Int. Cl. H04W 88/02

(52) U.S. Cl. 455/575.4

(57) ABSTRACT

A slide mobile phone is provided. The slide mobile phone may include a first main body, a second main body connected to perform a sliding movement while contacting with the first main body, a rail formed along an inner side surface of the first main body, a keypad installed at the first main body and having a projection received in the rail in a side surface, and spring members installed within the first main body for supporting the keypad. The keypad can vertically move by extension and compression of the plurality of spring members when the second main body is moved according to an opening and/or closing movement.

### CROSS REFERENCE TO RELATED APPLICATION

This application claims priority from and the benefit of Korean Patent Application No. 10-2009-0003753, filed on Jan. 16, 2009, which is hereby incorporated by reference for all purposes as if fully set forth herein.

### BACKGROUND OF THE INVENTION

1. Field of the Invention

Exemplary embodiments of the present invention relate to a slide mobile phone having a pop-up keypad.

Description of the Background

In general, a mobile phone can be classified as a bar-type, flip-type, folder-type, and slide-type according to an external form of the mobile phone.

The bar-type mobile phone may have a key input unit, which may be a data input means, a display unit, which may be a data output means, a mouthpiece module, and an earpiece module that are mounted in a main body housing. The flip-type mobile phone may include a main body, flip, and hinge for rotatably connecting the main body and the flip. The folder-type mobile phone may include a main body, folder, and hinge for rotatably connecting the main body and the folder, and may have a structure in which the folder is opened and closed by rotating about the main body.

The slide-type mobile phone may perform a predetermined function while opening and closing the main body by completing a sliding movement of the slider relative to the main body. In the slide-type mobile phone, a keypad in which alphanumeric keys are arranged in an n×m matrix may be provided in the main body and a display, a speaker, and function buttons may be provided in the slider.

In the slide-type mobile phone, because the keypad is fixed to the main body, upon a sliding-opening movement (e.g., opening the main body), a step may occur between the keypad and the slider. Therefore, when a user uses the keypad, it may be difficult to input a key, and when performing communication, a step may be uncomfortably experienced by the user at a surface contacting the user's skin.

Further, when the slider performs a horizontal movement, the slide-type mobile phone may be opened or closed. Therefore, when the user uses the mobile phone, in order to optimize a liquid crystal display of the slider and a line of sight of the user, the user may have to incline the mobile phone by a predetermined angle.

### SUMMARY OF THE INVENTION

Exemplary embodiments of the present invention provide a slide mobile phone that can conveniently perform key input upon a sliding opening movement and provide a comfortable feeling to a user when executing a communication function.

Exemplary embodiments of the present invention also provide a slide mobile phone that can obliquely open a slider by a predetermined angle in order to optimize a display of the slider and a line of sight of a user in a sliding opening state.

Additional features of the invention will be set forth in the description which follows, and in part will be apparent from the description, or may be learned by practice of the invention.

Exemplary embodiments of the present invention disclose a phone including a first main body, a second main body, a rail, a keypad, and a plurality of spring members. The second main body is connected to the first main body. The rail is formed in the first main body. The keypad is formed in the first main body and has a projection configured to move along the rail. The plurality of spring members is formed in the first main body for supporting the keypad. The keypad vertically moves by extension of the spring members in response to a sliding-opening movement of the second main body to lift the keypad and by compression of the spring members in response to a sliding-closing movement of the second main body to retain the keypad between the first main body and the second main body.

Exemplary embodiments of the present invention disclose a phone including a first main body, a second main body, a guide, a keypad, a support structure, and a plurality of spring members. The first main body includes a first space portion including a guide groove and a second space portion including a rail. The second main body is connected to the first main body. The guide is connected to the second main body and has a protruding portion received in is the guide groove to guide a sliding movement of the second main body. The keypad is formed in the second space portion of the first main body. The support structure includes a first support portion being coupled to the first space portion and a second support portion being coupled to the second space portion. The first support portion is configured to support the guide. The second support portion includes a projection configured to move along the rail and to support the keypad. The plurality of spring members is formed in the second space portion of the first main body for supporting the support structure.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a perspective view of a slide mobile phone according to exemplary embodiments of the present invention.

FIG. 2 is a side cross-sectional view illustrating a sliding-opening movement of the slide mobile phone of FIG. 1, according to exemplary embodiments of the present invention.

FIG. 3 is a perspective view illustrating a slide mobile phone after completion of the sliding-opening movement according to exemplary embodiments of the present invention.

FIG. 4 is a perspective view of a slide mobile phone of a pop-up keypad structure is according to exemplary embodiments of the present invention.

FIG. 5 is a side cross-sectional view illustrating a sliding-opening movement of the slide mobile phone of FIG. 4, according to exemplary embodiments of the present invention.

FIG. 6 is a perspective view of a slide mobile phone according to exemplary embodiments of the present invention.

FIG. 7 is a side cross-sectional view illustrating a sliding-opening movement of the slide mobile phone of FIG. 6, according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

In the following description, exemplary embodiments described are related to, but not limited to, a mobile phone. For example, a pop-up keypad structure applied to the mobile phone can be applied to slide-type devices, an information and communication device, or a multimedia device, such as a mobile terminal, mobile phone, wired or wireless phone, portable multimedia player (PMP), personal digital assistant (PDA), and smart phone.

Hereinafter, exemplary embodiments of the present invention are described in detail with reference to the accompanying drawings.

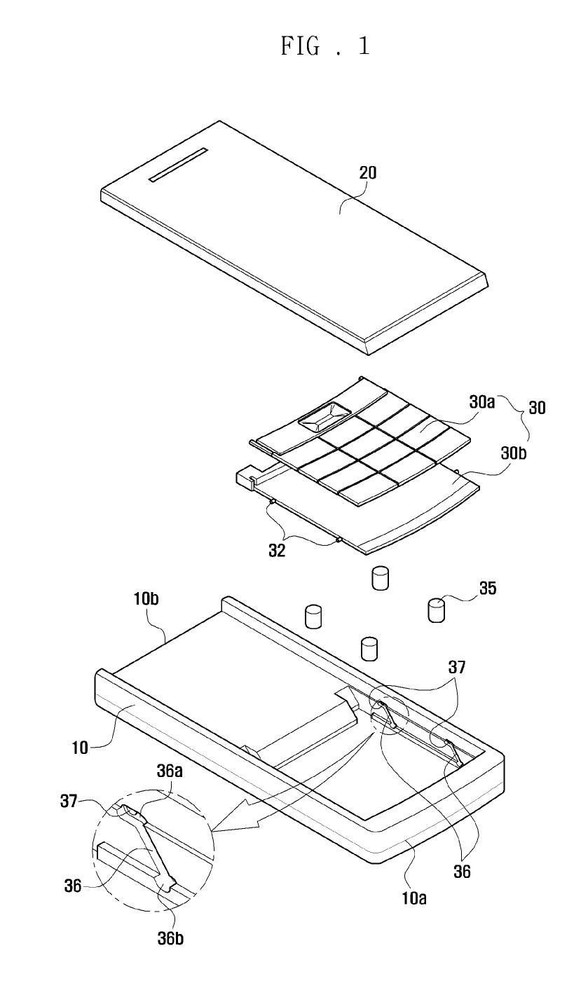

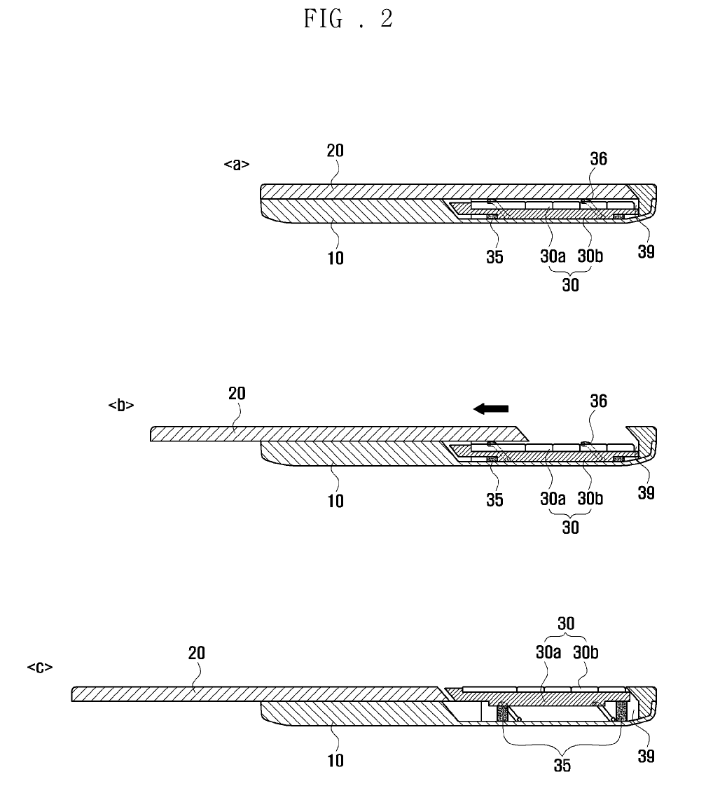

FIG. 1 is a perspective view of a slide mobile phone of a pop-up keypad structure according to exemplary embodiments of the present invention. FIG. 2 is a side cross-sectional view illustrating a sliding-opening movement of the slide mobile phone of FIG. 1.

Referring to FIG. 1, a slide mobile phone may include a first main body 10, a second main body 20, a keypad 30 installed at the first main body 10, and a plurality of spring members 35 installed within the first main body 10 and for supporting the keypad 30. The second main body 20 may be connected to perform a sliding movement while contacting with the first main body 10.

A rail 36 for supporting a pop-up movement path of the keypad 30 may be formed on an inside surface of the first main body 10. A housing portion 39 for housing one end of the keypad 30 may be formed at an end portion 10a. The second main body 20 may support a slider for the first main body 10. A speaker and a display may be integrated in the second main body 20. The keypad 30 may include a key input unit 30a and a support portion 30b for supporting the key input unit 30a. On a side surface of the support portion 30b, a projection 32 to be received along the rail 36 may be formed. In the support portion 30b, contact points (not shown) corresponding to each button of the key input unit 30a may be formed. A pattern for executing one or more functions according to an input of each button may be formed.

The rail 36 may be formed in several suitable ways, for example, in a curved line or an oblique line, and may have a fan-shaped circular arc form. Upon a sliding-opening movement, the keypad 30 may escape from the housing portion 39. For example, the keypad 30 may be lifted or popped up in response to the sliding-opening movement. If a user vertically presses the key input unit 30a, a direction of the rail 36 and a direction of a force due to the key input unit 30a being pressed are different, and thus pop-up of the keypad 30 can be suppressed.

An upper end portion 36a of the rail 36 may extend horizontally. When the keypad 30 is popped up, because a projection 32 along the rail 36 is received in a horizontally-extended portion, a popped-up keypad 30 can be more comprehensively secured against a force pressing the key input unit 30a.

In the upper end portion 36a of the rail 36, a latch recess 37 to which the projection 32 is to be coupled may be formed. The projection 32 may be formed with an elastic member. For example, when the projection 32 moves along the rail 36, the projection 32 may move in a compressed state, but when the keypad 30 is popped-up, the projection 32 may elastically couple to the latch recess 37 while extending from the latch recess 37 and comprehensively secure the popped-up keypad 30. When a force is applied in a sliding-closing movement, the projection 32 may escape from the latch recess 37 and may move along the rail 36. In the sliding-closing movement, the keypad 30 may be retained in the housing portion 39 and the keypad 30 may no longer be popped up in response to the sliding-closing movement.

After being retained in a sliding-closing state, the keypad 30 may be opened and the spring member 35 may pop up the keypad 30 in response to a sliding-opening movement. The spring member 35 may be installed at the inside of the first main body 10 and a lower part of the keypad 30. A suitable number of spring members 35 for enabling pop-up of the keypad 30 may be installed.

Referring to FIG. 2, a sliding-opening movement of a slide mobile phone having a pop-up keypad structure according to exemplary embodiments is described.

In FIG. 2(a), in a sliding-closing state, an end portion of the keypad 30 may be housed in the housing portion 39; the spring member 35 may be in a compressed state; and the projection 32 may be positioned at a lower end portion 36b of the rail 36.

In FIG. 2(b), when the user pushes the second main body 20 in, for example, a direction indicated by the arrow (e.g., along the rail, away from the keypad 30), the second main body 20 may perform a sliding-opening movement in the arrow direction until the keypad 30 no longer overlaps the second main body 20. During the sliding-opening movement, the keypad 30 may remain within the first main body 10 of FIG. 2(a).

In FIG. 2(c), when the sliding movement of the second main body 20 is complete and the second main body 20 is in a sliding-opening state, the keypad 30 may be popped up along the rail 36 by the elasticity of the spring member 35. The popped-up keypad 30 may be secured as the projection 32 is elastically coupled to the latch recess 37 formed in the upper end portion 36a of the rail 36, or as the projection 32 is coupled to the upper end portion 36a horizontally extended to the rail 36.

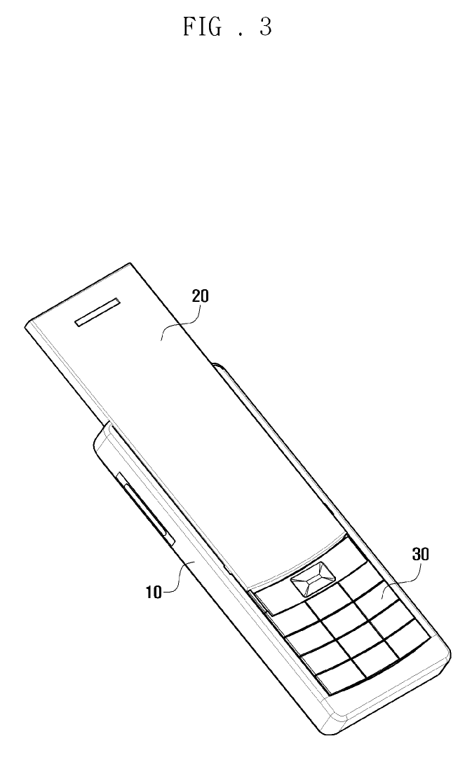

FIG. 3 illustrates a slide mobile phone after completion of the sliding-opening movement.

Referring to FIG. 3, because the keypad 30 in a pop-up state may be positioned at the same plane as that of the second main body 20, a step does not occur between the keypad 30 and the second main body 20. Thus, the user can experience a comfortable feeling when inputting a key through the keypad 30, or when executing a communication function.

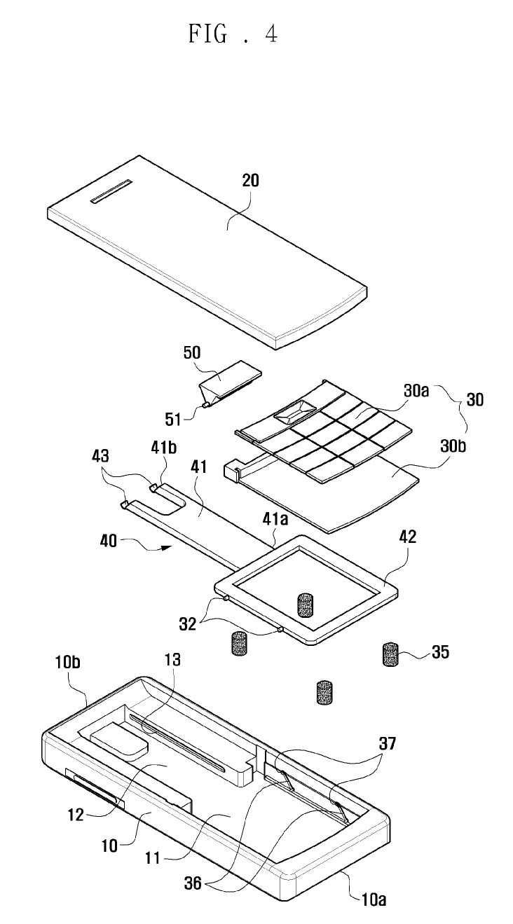

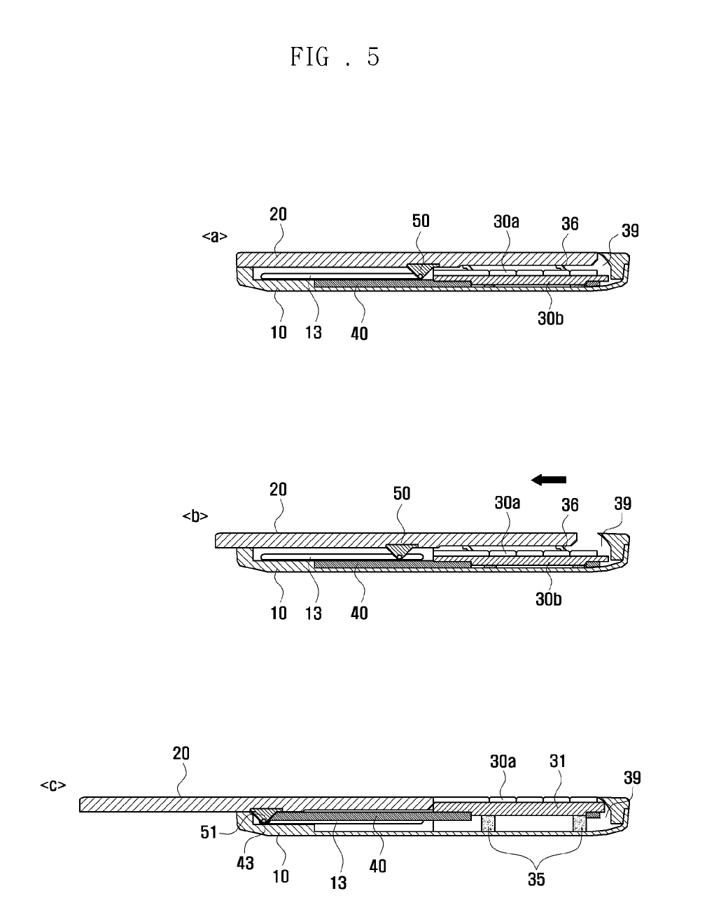

FIG. 4 is a perspective view of a slide mobile phone according to exemplary embodiments of the present invention. FIG. 5 is a side cross-sectional view illustrating a sliding-opening movement of the slide mobile phone of FIG. 4. Detailed descriptions of elements identical to or corresponding to those of the slide mobile phone described with reference to FIG. 1, FIG. 2, and FIG. 3 may be omitted.

Referring to FIG. 4, a first main body 10 may include a first space portion 11 in is which a guide groove 13 is formed in a side surface of the first main body 10 and a second space portion 12 in which a rail 36 is formed in a side surface of the first main body 10. A plurality of spring members 35 may be installed at the second space portion 12, and a support structure 40 may be disposed between the spring member 35 and the keypad 30. The support structure 40 may include a first support portion 41, which is a portion received in the first space portion 11, and a second support portion 12, which is a portion received in the second space portion 42. A projection 32 may move along the rail 36 and may be formed on a side surface of the second support portion 42 or along a side surface of a support portion 30b of the keypad 30.

A guide 50 for guiding a sliding movement of the second main body 20 may be attached to a lower part of the second main body 20. The guide 50 may have a protruding portion 51 received in the guide groove 13, as shown in FIG. 4.

In the support structure 40, a first support portion 41 may be a portion for supporting the guide 50. When the protruding portion 51 of the guide 50 moves along the guide s groove 13, the guide 50 may move along a surface of the first support portion 41 and thus the second main body 20 may perform a sliding movement. The second support portion 42 may be a portion for supporting the keypad 30. When a sliding-opening movement is complete, the projection 32 may move along the rail 36 and support the keypad 30 to pop up. A latch recess 37 may be formed in an upper end portion 36a of the rail 36.

In a sliding-closing state, the support structure 40 may be pressed down by the guide 50 and the second main body 20. When the guide 50 separates from the first support portion 41 by moving along a surface of the first support portion 41, the support structure 40 may be free and may rise, thereby lifting or popping up the keypad 30.

A ring 43 formed to have a step from a surface of the first support portion 41 may is be provided at an end portion 41b of the first support portion 41. When the guide 50 performs a sliding movement during a sliding-opening movement using a step in the end portion 41b of the first support portion 41, the protruding portion 51 may reach the ring 43 thereby stopping the sliding movement of the guide 50. In some cases, when the guide 50 performs a sliding movement from the end portion 41b of the first support portion 41, a sliding movement of the guide 50 may be stopped by an inside surface of the first space portion 11. Accordingly, the ring 43 may not be necessary.

The first support portion 41 may be positioned along the same plane as that of the second support portion 42. However in a sliding-closing state, if the second main body 20 is retained within the first main body 10, the first support portion 41 may protrude higher than the second support portion 42 by a predetermined height. This is because in a sliding-opening movement, a sliding movement can be performed when the second main body 20 separates from the other end portion 10b of the first main body 10. For example, upon a sliding-opening movement, the guide 50 may move along a surface of the first support portion 41, and the second main body 20 may separate from the other end portion 10b of the first main body 10 by a height of the first support portion 41 and perform a sliding movement.

Referring to FIG. 5, a sliding-opening movement of a slide mobile phone is described according to exemplary embodiments of the present invention.

In FIG. 5(a), in a sliding-closing state, the guide 50 may be positioned at the end portion 41a of the first support portion 41. The keypad 30 and an end portion of the second support portion 42 may be retained in the housing portion 39. The spring member 35 may be in a compressed state, and the projection 32 may be positioned at a lower end portion 36b of the rail 36.

In FIG. 5(b), when the user pushes the second main body 20 in, for example, a direction indicated by the arrow (e.g., along the rail, away from the keypad 30) and the guide 50 moves along a surface of the first support portion 41, the second main body 20 may perform a sliding movement in the arrow direction until the keypad 30 no longer overlaps the second main body 20. The keypad 30 may continue to be retained within the first main body 10, as shown in FIG. 5(a) and FIG. 5(b).

After completing the sliding motion illustrated in FIG. 5(b), the guide 50 may separate from the first support portion 41, the support structure 40 may no longer be held in position by the guide 50, and the keypad 30 may no longer overlap the second main body 20. By the elasticity of the spring member 35, the support structure 40 may pop the keypad 30 while also rising along the rail 36 as shown in FIG. 5(c). If a latch recess 37 is formed in the upper end portion 36a of the rail 36, the projection 32 may be elastically coupled to the latch recess 37 and thus a popped-up keypad 30 can be secured.

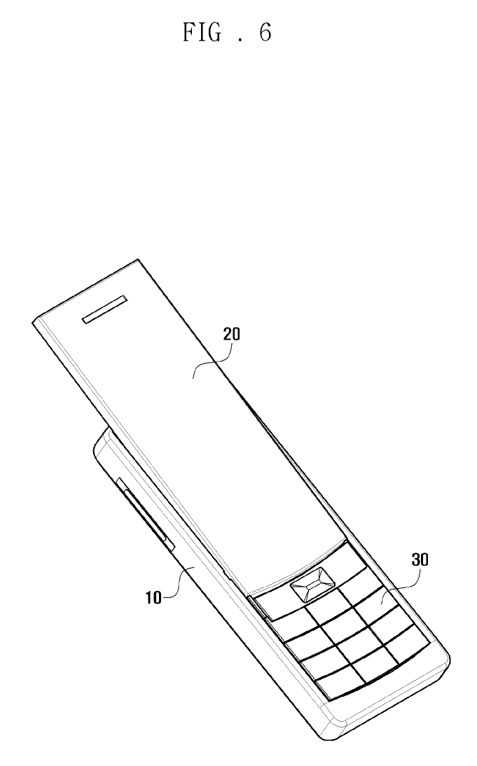

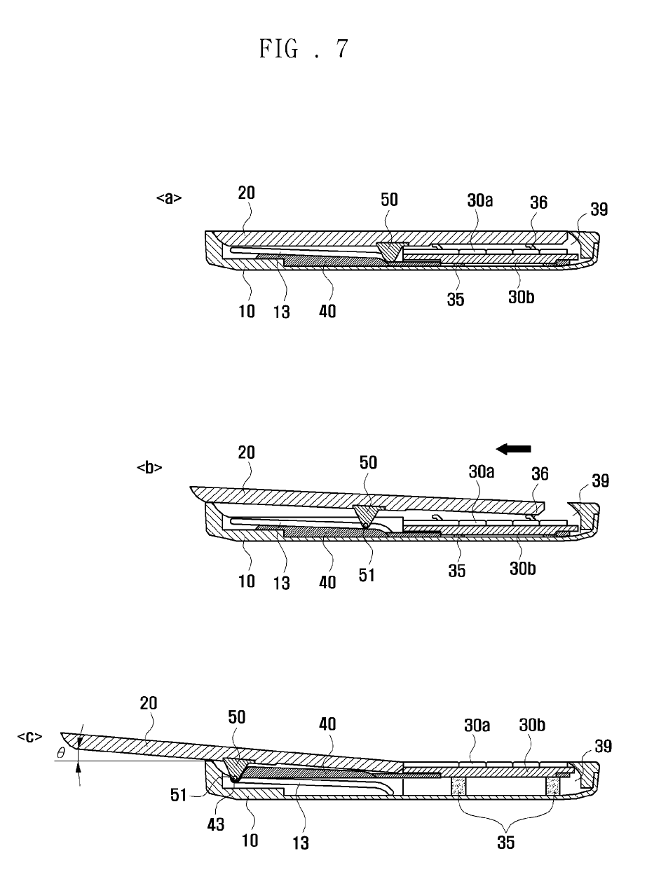

FIG. 6 is a perspective view of a slide mobile phone according to exemplary embodiments of the present invention. FIG. 7 is a side cross-sectional view illustrating a sliding-opening movement of the slide mobile phone of FIG. 6. Detailed descriptions of elements identical to or corresponding to those of the slide mobile phone described with reference to FIG. 1, FIG. 2, FIG. 3, FIG. 4, and/or FIG. 5 may be omitted.

Referring to FIG. 6, a surface of the first support portion 41 may be formed as an inclined surface, and the guide 50 may move along the inclined surface. In a sliding-opening state, the second main body 20 may obliquely move according to a predetermined angle and the keypad 30 may be lifted or popped up. Accordingly, a display of the second main body 20 can be provided at an optimum angle to the user. In a sliding-closing state, the second main body 20 is may be retained in the first main body 10. Upon a sliding-opening movement, for the second main body 20 to perform a sliding movement, the end portion 41a of the first support portion 41 may protrude from a surface of the second support portion 42 by a predetermined height.

Referring to FIG. 7, in FIG. 7(a), during a sliding-closing state, the guide 50 may be positioned at the end portion 41a of the first support portion 41. The keypad 30 and an end portion of the second support portion 42 may be retained in the housing portion 39, the spring member 35 may be in a compressed state, and the projection 32 may be positioned at the lower end portion 36b of the rail 36.

In FIG. 7(b), when the user pushes the second main body 20 in, for example, a direction indicated by the arrow (e.g., along the rail, away from the keypad 30) and the guide 50 moves along an inclined surface of the first support portion 41, the second main body 20 may perform a sliding movement at an inclined angle of the first support portion 41 until the keypad 30 no longer overlaps the second main body 20. The keypad 30 may initially remain at a lower part of the first main body 10, as shown in FIG. 7(a) and FIG. 7(b).

After completing the sliding motion illustrated in FIG. 7(b), the guide 50 may separate from the first support portion 41, the support structure 40 may no longer be held in position by the guide 50, and the keypad 30 may no longer overlap the second main body 20. By the elasticity of the spring member 35, the support structure 40 may pop the keypad 30 while also rising along the rail 36 as shown in FIG. 7(c). If a latch recess 37 is formed in the upper end portion 36a of the rail 36, the projection 32 may be elastically coupled to the latch recess 37 and thus a popped-up keypad 30 can be secured.

As shown in FIG. 7(c), when pop-up of the keypad 30 is complete, one end of the second main body 20 may contact one end of the keypad 30. There is no step between the is second main body 20 and the keypad 30, and the second main body 20 may be inclined by an angle θ of an inclined surface of the first support portion 41. In general, any suitable incline angle θ may be used.

When a surface of the first support portion 41 is formed in an inclined surface at an angle θ, the second main body 20 may be inclined by the inclined surface in a sliding-opening state. A display of the second main body 20 may thus provide an optimum angle to the user.

As described above, in response to a sliding-opening movement, a keypad may be popped up, and a step between the keypad and a second main body may be removed. Accordingly, the keypad can be conveniently used while executing a communication function, and a user can experience a comfortable feeling along a surface of the mobile phone that may be contacting the user.

Further, upon a sliding movement, as the second main body performs a sliding movement at an inclined angle, a line of sight of the user relative to the second main body can be optimized.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A phone, comprising:
a first main body;
a second main body is connected to the first main body;
a rail formed in the first main body;
a keypad formed in the first main body and having a projection configured to move along the rail; and
a plurality of spring members formed in the first main body for supporting the keypad,
wherein the keypad vertically moves by extension of the spring members in response to a sliding-opening movement of the second main body to lift the keypad and by compression of the spring members in response to a sliding-closing movement of the second main body to retain the keypad between the first main body and the second main body.

2. The phone of claim 1, wherein the first main body comprises a housing portion to house one end of the keypad in a sliding closing state.

3. The phone of claim 1, wherein the rail is formed in one of a curved line or an oblique line.

4. The phone of claim 3, wherein an upper end portion of the rail extends horizontally.

5. The phone of claim 1, wherein the projection comprises an elastic member, and
wherein a latch recess elastically coupled to the projection is formed at an upper end portion of the rail.

6. The phone of claim 1, wherein the keypad comprises a key input unit and a support portion for supporting the key input unit.

7. A phone, comprising:
a first main body comprising a first space portion comprising a guide groove and a second space portion comprising a rail;
a second main body connected to the first main body;
a guide connected to the second main body and having a protruding portion received in the guide groove, the guide configured to guide a sliding movement of the second main body;
a keypad formed in the second space portion of the first main body;
a support structure comprising a first support portion being coupled to the first space portion and a second support portion being coupled to the second space portion, the first support portion configured to support the guide, the second support portion comprising a projection configured to move along the rail and to support the keypad; and
a plurality of spring members formed in the second space portion of the first main body for supporting the support structure.

8. The phone of claim 7, wherein a surface of the first support portion is formed at an inclined surface.

9. The phone of claim 7, wherein the first support portion comprises a ring to have a step from a surface of the first support portion and to receive the protruding portion of the guide in response to a sliding-opening movement.

10. The phone of claim 7, wherein, in a sliding-closing state, the second main body is retained in the first main body, and
the first support portion protrudes from a surface of the second support portion.

11. The phone of claim 7, wherein the first main body comprises a housing portion to house one end of the keypad in a sliding closing state.

12. The phone of claim 7, wherein the rail is formed in one of a curved line or an oblique line.

13. The phone of claim 12, wherein an upper end portion of the rail extends horizontally.

14. The phone of claim 7, wherein the projection comprises an elastic member, and
wherein a latch recess elastically coupled to the projection is formed at an upper end portion of the rail.

15. The phone of claim 7, wherein the keypad comprises a key input unit and a support portion for supporting the key input unit.

16. The phone of claim 7, wherein the keypad vertically moves by extension of the spring members in response to a sliding-opening movement of the second main body to lift the keypad and by compression of the spring members in response to a sliding closing movement of the second main body to retain the keypad between the first main body and the second main body
